(19) United States
(12) Patent Application Publication
(10) Pub. No.: US 2024/0265019 A1
(43) Pub. Date: Aug. 8, 2024

(54) HYPERAUTOMATION WHEEL (HAW)

(71) Applicant: Hyland Software, Inc., Westlake, OH (US)

(72) Inventors: Scott York, Cheshunt (GB); Scott Caesar, Rockford, MI (US)

(21) Appl. No.: 18/105,334

(22) Filed: Feb. 3, 2023

(51) Int. Cl. G06F 16/2457; G06F 16/22; G06F 16/28

(52) U.S. Cl. CPC G06F 16/24573; G06F 16/2228; G06F 16/287

(57) ABSTRACT

A hyperautomation wheel configures a visually structured sequence according to metadata obtained from disparate systems of an enterprise. The metadata is gathered into different stages for various application functions to provide one or more end process solutions. The stages are configured into the visually structured sequence to provide a functional visualization of an end process solution to one or more products of the enterprise. The stages can be tested, re-configured, modified, or implemented across the disparate systems.

### FIELD

This disclosure relates to computerized networks and data management systems with a hyperautomation wheel (HAW) across enterprises within the healthcare field or otherwise.

### BACKGROUND

Computerized networks and data management systems can include a variety of systems, devices, and technologies to enable users to create, store, access, and distribute information. Such systems can include one or more wired networks, wireless networks, or a combination thereof, including software, hardware and firmware on different platforms. Each system can include a broad range of interconnected devices, each comprising hardware, software, virtualization technology, etc., which enables the devices to send, receive, process, or store information to provide different functionality. Examples of such devices can include user equipment (UE), including mobile UE devices (e.g., cell phones, tablet computers, laptop computers, etc.), stationary devices (e.g., desktop computer, servers, workstations, etc.), and network components and devices (e.g., network hubs, routers, base stations, satellite systems, etc.).

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example network environment according to various aspects described herein.

FIG. 2 is a diagram of an example computing system or device for a hyperautomation wheel according to various aspects described herein.

FIG. 3 is a diagram of another example of a hyperautomation wheel according to various aspects described herein.

FIG. 4 is a diagram of an example workflow stage of a hyperautomation wheel according to various aspects described herein.

FIG. 5 is a diagram of another example of a hyperautomation wheel according to various aspects described herein.

FIG. 6 is a diagram of an example of analytics and reports by an analytics component of a hyperautomation wheel according to one or more implementations described herein.

FIG. 7 is diagram of an example of administrative options for configuring a hyperautomation wheel according to various aspects described herein.

FIG. 8 is a diagram of an example model structure of processes for a hyperautomation wheel according to various aspects described herein.

FIG. 9 is an example process flow for configuring a hyperautomation wheel according to various aspects described herein.

FIG. 10 is a diagram of another example model structure of processes for a hyperautomation wheel according to various aspects described herein.

### DETAILED DESCRIPTION

The following detailed description refers to the accompanying drawings. Like reference numbers in different drawings can identify the same or similar features, elements, operations, etc. Additionally, the present disclosure is not limited to the following description as other implementations can be utilized, and structural or logical changes made, without departing from the scope of the present disclosure.

Various disparate systems operating in an enterprise can function independently of one another for the operation of enterprise business. An enterprise, for example, can include one or more corporations or legal entities operating together with proprietary systems that include software, hardware and firmware to provide processes for end-to-end solutions for various applications and products. The enterprise can include a business, company, corporation or other entity suitable for conducting business-related activities, such as finance operations, human resources, customer and sales management, manufacturing or the other like business-related activities, for example, under one legal entity. An enterprise can include an organization of multiple different legal entities for various business operations or business-related activities. A computing environment or platform can include a user's work station or computing device that enables interaction with and execution of a selection and a configuration of various application modules/components within segments of business that the disparate systems operate across.

An example of a disparate system can be an enterprise resource planning (ERP) applications and systems that can assist in the management of day-to-day business activities, including accounting, finance, procurement, project management, risk management, compliance, manufacturing, and supply chain operations. An ERP system includes performance management of a business organization to enable planning, budgeting, prediction, and reports associated with the organization's financial results. The ERP ties together multiple business processes to enable the flow of data between them, elimination of data duplications, data integrity, and the support of each aspect of business, including financial management, human resources, supply chain management, and manufacturing with accounting. Similar to an ERP system, is a system applications and processing (SAP) system. Other systems within an enterprise can include security based systems for controlling the log in or access to individual systems, as well as data capture systems that deliver automated processing and communication of unstructured or structured documents to alleviate manual keying and management of such data.

Often, such as through acquisitions and mergers, for example, surviving legal entities are left with a legacy of disparate systems, applications, and infrastructure. This means extra work may be needed to maintain multiple disparate systems, instead of a single large one. Many insurers, for example, still struggle to manage a complete web of legacy silos, disparate systems, redundant functionality, excess capacity and inconsistent service levels. A disparate system can be a system that is clearly different from another, either in business function or purpose, proprietary ownership, third party ownership external to the legal entity or enterprise, format, quality, type, software, function, etc., for example. A disparate system often can be on a different platform, and function within a different business sector or segment with different purposes as well as different securities for accessing and managing the software, hardware or firmware of the disparate systems, but may be on a same platform. A disparate system can be a computer data processing system designed to operate a fundamentally distinct data processing system without necessarily exchanging data or interacting with other computer data processing systems. Legacy systems are examples of disparate data systems as are heterogenous database data systems; these can be characterized as information silos because of a data systems isolation from or incompatibility with any other data system.

For example, a disparate system that is proprietary can include one or more software/firmware systems (e.g., a Hyland Software Product Suite, OnBase, or Robotic Process Automation (RPA)), while a third party system could include Workday Financial Management, Systems Applications and Products (SAP), an ERP, or another system, for example.

In an aspect, a hyperautomation wheel can operate to abstract data or metadata from disparate systems within an enterprise. The disparate systems can be proprietary, third party systems originating from external parties of the enterprise such as by a license, or both internal systems that are proprietary and external systems that are third party systems. For example, a disparate system that is proprietary can include one or more software/firmware systems such as a Hyland Software Product Suite, OnBase, and Robotic Process Automation (RPA), while a third party system could include Workday Financial Management, Systems Applications and Products (SAP), an ERP, or another system.

The hyperautomation wheel can provide a visual structure, such as a wheel structure or other visual sequence structure made of various stages visualized as spokes of the wheel or stages in the visual sequence of different applications involved in an end-to-end process solution. The hyperautomation wheel thus provides functional visualization of end process solutions for one or more different products in an enterprise using the metadata from the disparate systems by executing automation processes, which can be associated with one or more visual structures (e.g., a wheel structure or other visually structured sequence).

In one aspect, the hyperautomation wheel visualizes end-to-end processes that involve disparate systems, whether something is being produced or manufactured on a Pacific Island overseas, or a third party, in such a way that end users are able to monitor which system events are happening within the processes and easily monitor across the flow of those systems, associated processes or solution solutions for one or a combination of products in the enterprise. One example process solution involving multiple process across multiple different legal entities or businesses of an enterprise might be accounts payable invoicing. The hyperautomation wheel can enable a single place to monitor, configure, test and extend end-to-end solutions that involve multiple technologies (e.g., web platforms, database management systems, operating systems, on-demand service platforms, end-point security platforms, robotic software/automation platforms, including other different technologies such as Internet of Things (IoT) systems, security service systems, or the like) for efficient handling across disparate systems of a business enterprise in a visualized and functional structure without independently logging into each disparate system or managing the settings of any one system.

In particular, understanding the process mechanics of different or disparate systems can be a barrier to implementing them. The complexity compounds for multiple disparate systems being used for a single solution with the cost of building and supporting the solution along with training needed over the lifespan of the solution. This can mean lost business, especially within smaller to medium sized businesses or enterprises of one or more legal entities. A solution as referred to herein can be a system, application or process that performs operations or generates products in response to a client demand, need or other objective.

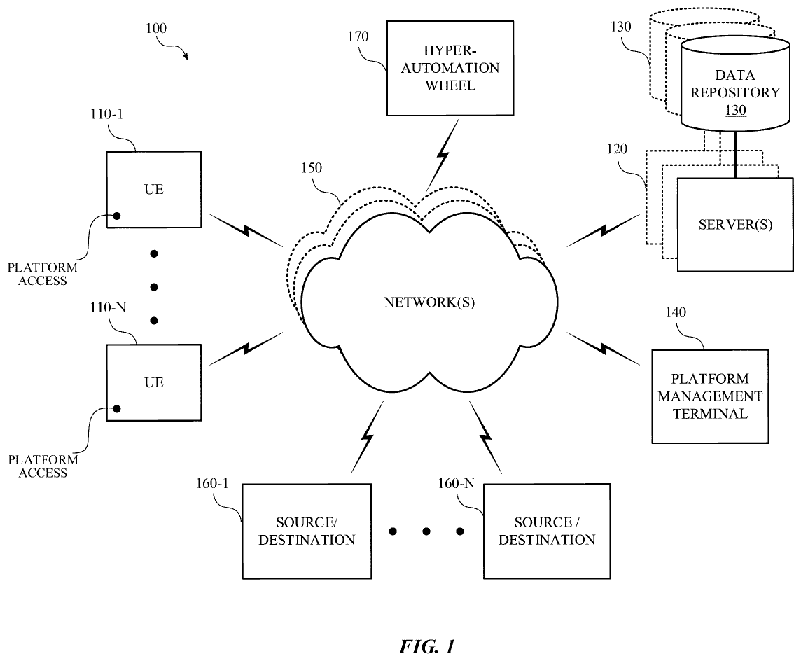

FIG. 1 is a diagram of an example environment 100 in which devices, systems or methods, described herein, can be implemented. As illustrated, environment 100 can include user equipment (UE) 110-1, . . . 110-N (where N is greater than or equal to 2 and collectively, or individually, can be referred to in this disclosure as UEs 110, UE 110, or UE device(s) 110), servers 120, data repositories 130, platform management terminal 140, network(s) 150, source/destination 160-1, . . . 160-M (where N is greater than or equal to 2 and collectively referred to as “sources/destinations 160”), and a hyperautomation wheel 170 communicatively coupled thereto. The number of devices or networks, illustrated in FIG. 1, is provided for explanatory purposes only. In practice, there can be additional devices or networks, fewer devices or networks, different devices or networks, or differently arranged devices or networks than illustrated in FIG. 1. Devices of environment 100 can interconnect via wired connections, wireless connections, or a combination thereof. Also, in some implementations, one or more of the devices of environment 100 can perform a functions described as being performed by another of the devices of environment 100.

UE or UE device 110 can include any type of computing device, system or computing architecture, such as a wired or wireless user device, that is capable of communicating with a network 150. For example, UE 110 can include a smartphone, tablet computer, laptop computer, wearable device, etc. UE 110 can alternatively include a desktop computer, a radiotelephone, a personal communications system (PCS) terminal (e.g., that can combine a cellular radiotelephone with data processing and data communications capabilities), a personal digital assistant (PDA) (e.g., that can include a radiotelephone, a pager, Internet/intranet access, etc.), or another type of computation or communication device. UE 110 can include any variety of peripheral devices, such as speaker, cameras, external storage devices, etc. UE 110 can include a browser or another type of application or interface capable of accessing a platform or network architecture hosted by servers 120. In an aspect, these can be digital imaging and communications in medicine (DICOM) or Non-DICOM based technologies that vary in other technology or standard across the disparate systems. A disparate system that is proprietary can include one or more software/firmware systems such as Brainware, OnBase, and Robotic Process Automation (RPA), for example, while a third party system could include Workday Financial Management, Systems Applications and Products (SAP), an ERP, or another system. Other examples of other technology or technology standards that also may be used as non-DICOM content to communicate metadata could be .pdf reports, medical images or related data stored in a native format common in medical fields as well as other document formats (.doc or the any other format). Other environments, technologies or standards are envisioned herein across the disparate systems that may be proprietary as internal to an enterprise or as third party systems originating external to the enterprise to be used for enterprise operations and products of the enterprise. The disparate systems can comprise different platforms across different segments of businesses associated with the enterprise, including one or more third-party systems. The disparate systems can further comprise different technologies including at least one of: sensor IoT based device(s), SAP components, ERM processes, automation system devices, or security services. For example, the disparate systems can include one or more of: Hyland Software Product Suite, OnBase, RPA, Workday Financial Management, or SAP.

The servers 120 can include one or more servers or other types of computing devices, systems or architectures capable of gathering, processing, searching for, storing, or communication information as described herein, including cloud servers. In some implementation, servers 120 can include an application server or a web server that stores one or more applications or that permits the one or more applications to be accessed or downloaded by UEs 110. The servers 120 can include a single server device, group of server devices, or one or more virtual servers with virtual machines, and components. In some implementations, servers 120 can comprise a platform as described herein. The platform can operate, in accordance with one or more standards or technologies (e.g., DICOM or non-DICOM), to receive, store, process, secure, or provide information as a computing environment with hardware, software, firmware or a combination thereof, with an operating system, a browser, and application programming interfaces for executing software. The platform can also, or alternatively, include one or more components, features, or processes capable of performing some or all of the aspects or techniques described herein. In some implementations, servers 120, in combination with one or more other types of devices, e.g., UEs 110, data repositories 130, platform management terminals 140, etc., can comprise a platform. In some implementations, servers 120 can include a vendor neutral achieve (VNA) system capable of receiving and storing information and other types of data from a variety of system sources, such as research instructions, hospitals, doctor offices, IoT networks, business systems or security systems, etc. In some aspects, servers 120 can also, or alternatively, be connected to a virtual cloud network (VCN) system and can retrieve metadata from any one of the disparate systems, as well as virtual machines, data centers with different network technologies or architectures according to aspects described herein.

Data repositories 130 can include one or more data storage devices capable of receiving, storing, and providing data related to DICOM information, the management and processing of DICOM information, etc. In some implementations, data repositories 130 can include a database, data center, or another type of data store, data storage system or framework for organizing and storing data. In some aspects, servers 120 and data repository 130 can be connected via network 150. Platform management terminal 140 can include any type of wired or wireless user device capable of communicating with servers 120 or data repositories 130 via network 150. Platform management terminal 140 can include a smartphone, tablet computer, laptop computer, desktop computer, or another type of user device capable of enabling a user, operator, administrator, or developer to interact with servers 120 or the platform. In some implementations, platform management terminal 140 can be a UE 110. Additionally, or alternatively, platform management terminal 140 can be directly connected to servers 120. In some implementations, data repositories 130 can be, or can be part of, a VCN system.

The sources/destinations 160 can include one or more computing systems or devices, such as a user devices, network devices, IoT network of sensors and other firmware, or server device capable of receiving, processing, storing, and communicating information via network 150. These system sources/destinations 160 can be owned or operated by a particular institution (e.g., a doctor's office, hospital, research institution, government agency, records archive, legal/business entity, etc.) or an enterprise. The system sources/destinations 160 can be capable of creating and sending information to servers 120 for processing or storage, as well as extracting or abstracting metadata for hyperautomation components described herein to automate processes and end process solutions for one or more products with the disparate systems. Additionally, or alternatively, sources/destinations 160 can request and receive information, such as metadata from servers 120 or form other source/destinations, as DICOM/Non-DICOM, internal/external, sources/destinations, which pertain to the disparate systems, for example, and their associated processes or product solutions. In some implementations, sources/destinations 160 can be a VCN system capable of receiving, storing, and distributing metadata or information to other servers 120 or other sources/destination system 160.

Network 150 can include a single network or multiple networks capable of enabling a connection between devices and different architectures of a platform (e.g., a DICOM platform or non-DICOM platform, including enterprise content services and management platforms for an enterprise of a legal entity). Network 150 can include one or more wired or wireless networks or network architectures with various interfaces associated with various UE configurations or systems, including application programming interfaces (APIs) between the disparate systems. Network 150 can include a Bluetooth® network, a Wi-Fi network, or a cellular network, the Public Land Mobile Network (PLMN), or a second generation (2G) network, a third generation (3G) network, a fourth generation (4G) network, a fifth generation (5G) network, a sixth generation (6G) network or another type of network. Additionally, or alternatively, network 150 can include a wide area network (WAN), a local area network (LAN), a metropolitan area network (MAN), an ad hoc network, an intranet, the Internet, a virtual network (e.g., a virtual private network (VPN)), a telephone network (e.g., a Public Switched Telephone Network (PSTN)), a Voice over IP (VoIP) network, or a combination of these or other types of networks.

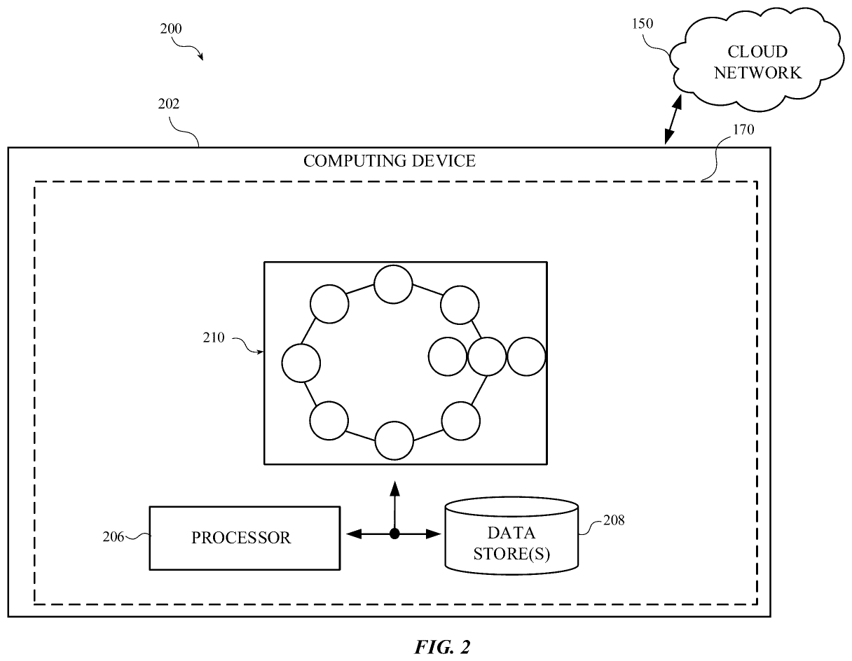

FIG. 2 illustrates an example hyperautomation wheel of a system or device 200 comprising a computing device 202 including a hyperautomation wheel 170, a processor 206, and a data store 208. The computing device 202 can be configured as one or more components of FIG. 1 such as a UE 110, server 120, or other component of the environment 100. The hyperautomation wheel 170 can operate to receive metadata from any one of disparate source systems 160, which can be obtained over the cloud or other network 150. The metadata information can be abstracted into the hyperautomation wheel 170 without having to directly enter into each source system 160 and configure a visible structure 210 of the metadata for particular processes or end process solution spanning the disparate source systems 160. The visual structure 210 that forms the hyperautomation wheel or other visually structured sequence can be configured into visible stages of different applications that are a part of an end-process solution, and each visual structure 210 of a number of visual structures can configure an end-process solution.

For example, an accounts payable (AP) invoicing across an enterprise can involve multiple processes based on multiple clients, associated services provided or received, product purchasing and deliveries, proposals, invoice entries, negotiations, payables received or outstanding, procurement, supply chains, etc. One or more of these processes can provide an end process solution for invoicing a particular service, product or combination of services and products, and may be contributed to by multiple disparate systems across legal entities or within an enterprise. The visual structure 210 can be configurable to integrate stages of a process flow or end process solution into a visual structure that can be tested, modified and established across the disparate systems based on the metadata obtained from the disparate systems over one or more platforms. Such metadata can be in the form of templates for any given solution allowing pre-configuration and repetition of the solutions to clients from a cloud based environment, making user end configuration more efficient and more automated over independently logging into each of the disparate systems and re-setting or re-configuring settings for various processes along associated stages to achieve the same result.

Although the visual structure 210 is described and illustrated as a wheel like structure, a wheel may or may not be the particular structure. For example, the visual structure 210 can be a honeycomb structure, or other shape of a process flow structure. The visual structure 210 can be a visually structured sequence of processes for achieving a particular end process solution (e.g., providing receipts for deliver, or other AP invoicing objective involving multiple systems).

The visual structure 210 can be used to visually reconfigure one or more sub-processes or stages, for example, based on a user visual reconfiguration or modification of the wheel structure, in which the user can visually re-arrange the processes and test the sequence of stages in the visually structured sequence with the metadata through the cloud 150 for the disparate systems to implement. Alternatively, or additionally, various stages can be added or removed from the visually structured sequence or visual structure 210 (e.g., a wheel structure as the hyperautomation wheel). For example, the visual structure 210 can be configured as a wheel, and the visual structure 210 comprise a wheel of processes as different stages; each stage in the process sequence can be set as a spoke of the wheel such that the stages can be visually ordered to re-process or continue the process flow or sequence according to the visual configuration across disparate systems for one or more products or services as an end process solution.

An end process solution can be a group of stages or software/firmware units that create a cross functional system for an enterprise or legal entity that when used as a structure for the integration and automation of a number of business processes to accomplish as a part of business duties such as manufacturing, logistics, distribution, accounting, finances, human resources, industrial controls or the like. The hyperautomation wheel 170 can a component, device or system that builds multiple hyperautomation wheels as visually structure sequences rendered in the display or user interface that can be configured, re-configured, and function to establish the management and integration of disparate systems for end process solutions based on the metadata abstracted out from the disparate systems.

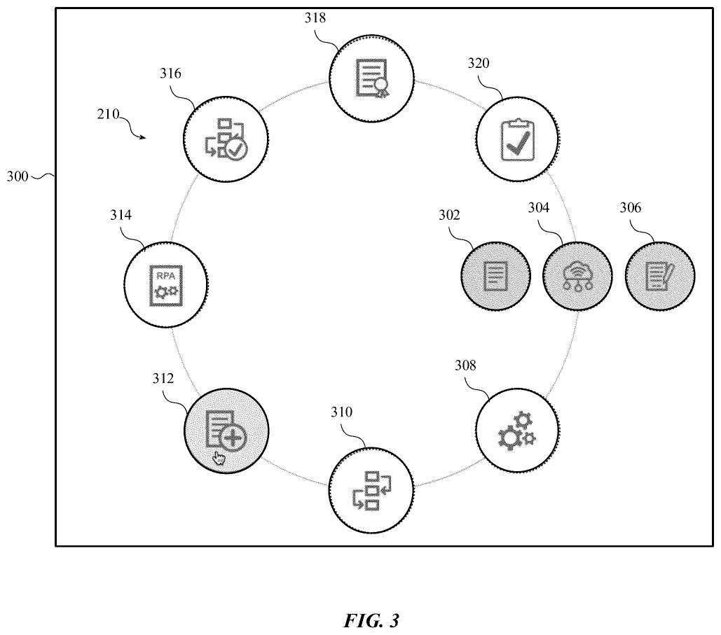

FIG. 3 illustrates another example of a hyperautomation wheel (HAW) component 300 configured to generate a visually structured sequence or visual structure 210 as a wheel structure of the HAW 170. The HAW component 300 is configured to receive a selection of a process that can include a document process 302, an IoT process 304, a form process 306 or other application function(s) for an end process solution. As such, different stages (e.g., 302 thru 320) can be configured by the HAW component 300 with different applications or application functions in an end-process solution.

In an aspect, the stages 302 thru 320 of the visual structure 210 can include various components including a process/process content stage 308, a workflow stage 310, a create process document stage 312, a robotic process automation (RPA) stage 314, a process action stage 316, a validation stage 318 or a complete or completion stage 320. Other various stages can be added, removed, or re-configured to connect at different stages of the visual structure 210 to function as a system of processes for an end process solution across disparate systems. Each stage 302 of the HAW 170 can operate to retrieve content to be used as a part of a hyperautomation process as the end process solution. The stages can operate by an extraction or abstraction of metadata from the cloud that is associated with the different disparate system. A stage can configure metadata from one disparate system, while a different stage configures metadata from another disparate system, thereby forming a visualization of application functions to be utilized in a single end process solution across the disparate systems of an enterprise. The stages in the visual structure 210 can thus onboard information and upload content to couple together system processes, monitor and test those processes.

The visual structure 210 can be built dynamically by an end user in a computing environment of the enterprise by initiating with a selection received from at least one of the document process stage 302, the IoT process stage 304, or the form process stage 306. The document process stage 302 can enable a process sequence associated with uploading files for hyperautomation processing, in which content or files can be uploaded or inserted into the visual structure 210. Likewise, the IoT process stage 304 can enable the configuring of various IoT processes for an IoT system to be configured according to various sensors, monitoring processes, or other software, hardware, and firmware for automation across disparate systems. The form process stage 306 can enable the monitoring and generation of forms within a process by configuring templates specific to hyperautomation process. Hyperautomation can refer to an automation of every process in an enterprise or organization that can be automated in order to streamline processes across businesses of an enterprise and/or third parties using artificial intelligence (AI) robotic process automation (RPA) and other technologies that may or may not span several disparate systems. As such, the HAW component 300 or HAW 170 or other visually structured sequence 210, for example, can update work processes, while removing or working around outdated work processes that are no longer efficient or effective in the business. While automation may refer to the achievement of a repetitive task without manual intervention, which is generally on a smaller scale that creates solutions designed to address individual tasks, hyperautomation can refer to including machine learning and robotic process automation (RPA) to scale automation initiatives or desired end process solutions with various application functions. As such, the HAW component 300 can dynamically configure these end process solutions in one or more visual structures 210 as wheels or other configurations to provide automation across disparate systems that include proprietary systems on a particular enterprise platform, as well as with third party systems.

In an aspect, the IoT process stage 304, for example, can be utilized to remove, add or modify sensors within an IoT network as a part of the end process solution. The sensors can include, for example, a motion sensor, button sensor, temperature sensor, voltage sensor, pressure sensor, power sensor, a critical event sensor or other sensor. The IoT process stage 304 can configure an identification of a sensor, the types of associated sensor values, a range of normalcy or threshold for the sensor data as a performance metric or key performance indicator, as well as monitoring sensors for transactions or the like, for example. The sensor data can then be input into the end process solution at a stage of the HAW. For example, if a delivery truck refrigerator rose above a sensed threshold, a work order could be generated from a template designed via the HAW along with other precautionary processes such as an inventory check, and external supplier availability, and subsequently shipping the item to a destination based thereon as an end process solution across disparate systems without repeating or not understanding the optimal or desired process being implemented over another. In this manner, the disparate systems can be easily integrated via the HAW to provide business efficiency for any number of different end process solutions with associated visual structures or wheel structures being configured with the disparate systems of an enterprise.

The process/process content stage 308 can further configure and provide a view or snapshot of content or metadata associated with or among each of the various stages. The process/process content stage 308 can further load various information that can be further detailed according to APIs created for the disparate systems or third party systems, message queues, or Json files stored in a document repository, for example. A content or content segments can indicate or snapshot a time stamp, a status of the processes/data of a stage component (e.g., being captured, validated, tested, completed, etc.), as well as the sector or business segment for the end process solution (e.g., Accounts Payable, Factory, etc.). Each of the viewable snapshot content associated with a stage can include an ID, session ID, a description, type of content, name, file process, and other information as it relates to a user and the last action associated with a selected stage. From the process content presented, the HAW component 300 can enter or drill into different HAWs or other visual structures that visualize other end process solutions that may intersect with the HAW 170 at one or more of the stages 302 thru 320.

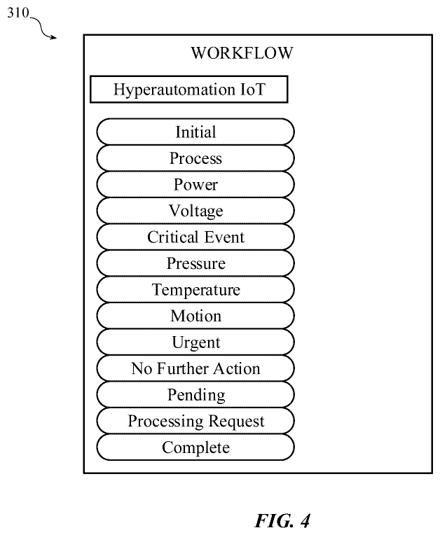

The workflow stage 310 as illustrated in further detail in FIG. 4 can provide selectable work items to manage tasks and issues to be addressed in the development of an end process solution or product. These work items can include selections including: “initial” for defining and setting up work items, “process” for processing, determining, or establishing a process or process template; “power” for sensing an IoT status, “voltage”, “critical event” for trigger generation of the process or sub-processes, “pressure”, “temperature”, “motion”, “urgent”, “no further action”, “pending action”, “process request”, “complete”, or the like, for example.

The create process document stage 312 is configured to obtain metadata that is collected from the disparate systems to create a document based on the metadata or a process occurring that provides information or feedback. The document can be generated as a template for use in an end process solution based on this metadata. The document can be used within any one or more of the disparate systems so that related processes have or utilize a similar or same template. A “critical event” as a part of the workflow stage 310, for example, can generate information or metadata that is put into a template from the create process document stage 312 in order to provide a trigger, an event report, a work item ticket, or other process (e.g., an order ticket, an inventory reporting of a particular product, a security report, or other event) for furthering the processes of the end process solution to be automated across the disparate systems or disparate source/destination systems.

The RPA stage 314 can be configured to extract information specifically from the RPA disparate system for robotic process automation software. Metadata can be extracted from the RPA disparate system and configured at the RPA stage 314 of the HAW 170, for example. The same can be configured from other disparate systems, such as a Hyland software product suite, OnBase, SAP, Workday, a Nuxeo system, or others, for example. As with other disparate systems, the associated stage of a disparate system can extract metadata associated with processes of that system and configure them within the HAW 210 as a part of an end process solution in a visual manner without having to independently log on and manage the particular disparate system.

Each stage 302 thru 320 can be configured for an end process solution associated with the visual structure 210 or HAW 170 and can further be associated with another visual structure associated with various processes or sub-processes for an end product solution of a particular disparate system. For example, the RPA stage 314 can include a HAW 170 or visual structure 210 with its own number and type of stage components for another set of processes or end product solution. This may in turn overlap with or be configured as a part of the HAW 170 or visual structure 210 as well, incorporating application functions or processes across disparate systems for the end process solution associated with the HAW 170 or visual structure 210, for example.

Other stages, for example, include a process action stage 316, validation stage 318 and complete or completion stage 320 that can further facilitate processes for testing, monitoring, reporting in log entries, modifying and further assessing a status of a process or sub-process throughout the disparate systems (source/destination systems) across the enterprise. The process action stage 316, for example, can activate the wheel structure or visual structure 210 for automation across the disparate systems, as well as execute relevant actions to complete an outcome for a given process. Validation stage 318 can operate to validate a process that has completed and write a log to decentralize a solution for auditing or compliance. The complete stage 320 can operate to finalize a process or clear it from the system.

Each of the stages 302 thru 320 can extract information or metadata from various different applications being used across the disparate systems. This information can be entered or gathered as visual functions fitting into the HAW structure or visual structured sequence 210. For example, where a disparate system comprises an OnBase system. OnBase can utilize applications for minimizing risk and supporting compliance by security storing, protecting or destroying information in accordance with applicable regulations, among other application functions. In the event of a trigger, key performance indicator, or other event, a critical event can generate a report for any number of reasons. This can then be used to generate a template by the metadata from OnBase and used in the processes for one or more other disparate systems, or all the disparate systems of the enterprise for uniformity or optimization. Alternatively, or additionally, a hybrid template could be made according to other security processes or critical event processes of other disparate systems, which can include a Hyland software product suite, RPA, OnBase, Workday Financial Management, SAP, or other disparate system of an enterprise, as internal and proprietary to the enterprise or as a third party disparate system, for example.

As each stage component 302 thru 320, which can be configured with more or less stages, obtains and gathers metadata associated with the particular stage processes/sub-processes, log information can be entered and monitored for following the status of each stage and the actions an end user has taken toward the stage in relation to the wheel structure or other visually sequenced structure 210. These processes can be performed via a cloud based server or network. In an aspect each stage can be configured to generate a set of content portions of metadata that correspond to processes according to a set of predetermined criteria and/or based on a set of user defined preferences/classifications associated with the particular stage. For example, each stage can include a set of logic (e.g., rule based logic or other reasoning processes) implemented with an artificial intelligence engine (not shown) such as via a rule based logic, fuzzy logic, probabilistic, statistical reasoning, classifiers, neural networks or other computing based platforms.

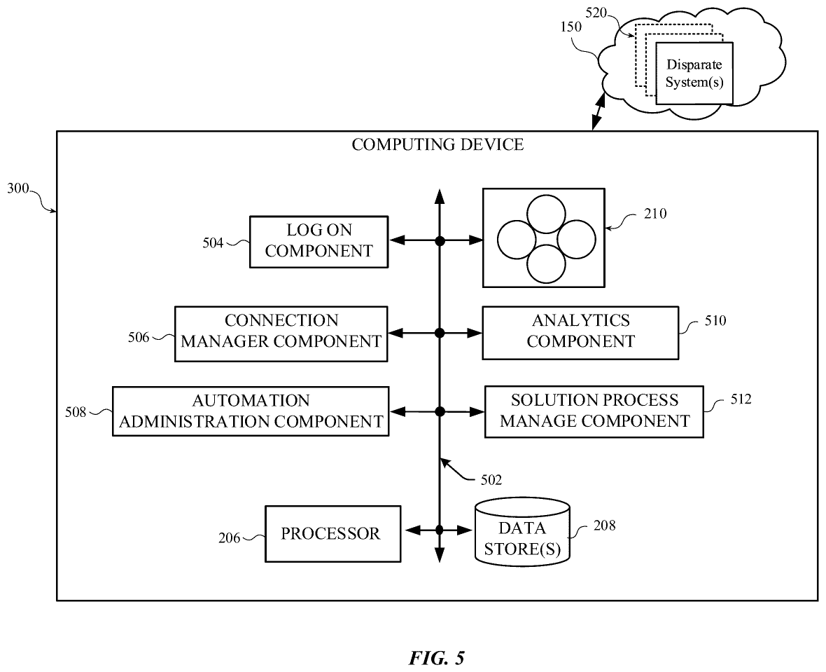

Referring to FIG. 5, illustrated is another example HAW component 300 in accordance with various aspects of this disclosure. Each component can be communicatively coupled via a communication line 502 (e.g., an optical link, a bus, a wireless connection, etc.). The HAW component 300 can further include a log-in, log on or logging component 504, a connection manager component 506, an automation administration component 508, an analytic component 510, and a solution process manage component 512.

The log on/log in or logging component 504 is configured to provide a single security to access the HAW component 300 and the metadata from the disparate systems, which can be access via cloud network 150. The log on component 504 operates as an access security component for access to the metadata of the enterprise, including both proprietary and any third party systems operating for any combination of products or end process solutions. The log on component 504 can provide a log-in interface that centralizes and unifies access to the metadata of all the disparate systems 520, without requiring individual user access already associated to each disparate system, including their own independent security/logging access protocols, respectively. The log on component 504 can provide a centralized and unified log on for access based on application programming interfaces (APIs) created from the metadata of the disparate systems 520 by the connection manager component 506 or other component, for example, in which the metadata can be associated with different automation processes of one or more different products or processes. The log on component 504 can enable HAW security via one or more of the disparate system processes (e.g., OnBase, or other disparate system) for a single login across all disparate systems of the enterprise, giving access to data about all the different products and configure solutions from end-to-end business processes as end process solutions, whether proprietary or third party based. The metadata abstracted from the disparate systems 520 can be accessed via a single log-in independently and in lieu of individual security logging and the independent management of each disparate system as part of the automation processes for hyperautomation by the HAW component 300. The metadata extracted and received from the disparate systems 520 can stored (e.g., cloud 150, data store(s) 208, or other storage (e.g., repository 130)) and translated into a common format for abstraction and use by the HAW component 300 to understand what processes, inputs and outputs are occurring with the disparate systems. This enables a unification of information to build the user interfacing with the HAW component and business logic among the disparate systems 520.

In an aspect, in response to receiving a central log-in access via the log on component 504 for the wheel structure or visual structure 210, other components (e.g., 506 thru 512 can operate to functionally integrate application functions of the disparate systems 520 into corresponding stages associated with each disparate system or the overall end process solution of each HAW 170 from among a plurality of HAWs.

For example, the connection manager component 506 can be configured to manage connections (e.g., 502, either wired or wireless) to the disparate systems 520 based on a security exchange such as a token exchange (e.g., an enterprise experience platform) such as a Hyland experience platform (HxP)) with a cloud-based platform or network 150. The connection manager component 504 manages the connections to the various disparate systems based on a session based token exchange, for example. As the security exchange token or token exchange becomes integrated into the enterprise platform via the connection management component 506, the token exchanges can be removed or replaced, rather than be configured to persist among the disparate systems. The API created via the log on component for the HAW 170 can then bridge into each the disparate systems with the HxP accounts to enable pulling out the information or metadata needed for end-to-end process solutions and the connection manager component 504 to manage the connections among the disparate systems and the HAW component 300, for example. The connection manager component 506 to obtain business metadata or content (e.g., business-related activity date or feedback) from various source systems (disparate systems 520), as well as legal entities and processes of the enterprise, aggregate the data, and dynamically communicate an analysis of a legal entity or business across segments of business-related activities or operations, one or more legal entities, one or more computing environments, or different stage components to provide an implementation output for use in the enterprise as an end process solution or product via the analytics component 510. The stage components (e.g., 302 thru 320) can be located together in one computing device, across multiple computing devices, the computing device(s) and the cloud 150, or configured dynamically as firmware/software components in a local system, distributed system or across a network as discussed herein.

In another example, in response to receiving a central log-in access, the automation administration component 508 can be configured to enable re-configuring of the visually structured sequence 210 based on changes in an automation process by adding a new source system with the plurality of disparate systems, adding or removing a stage 302 thru 320 of the visual structured sequence 210, or modifying a process flow sequence from among stages 302 thru 320 of the visual structured sequence 210. The HAW component system 170 or 300 can be managed in a cloud based client according to permissions allowing relevant metadata content to be pushed in a visualization to an end user or user device (e.g., a UE). The automation administration component 508 enables construction of the visual structure 210 or visually structured sequences and their configuration for one or more end process solutions for one or more products. This enables a visualization of application functions across the disparate systems and their configuration to be modified, either with a lessor or greater number of stages, at different stages or positions in the wheel structure or visual structured sequence 210, as well as the HAW's implementation across business segments, applications, or products across each disparate system with testing, validation and completion logging of the end process solution. This logging enables the analytics and reports to be generated via the analytics component 510. The automation administration component 508 can include executable instructions, or code, to deploy each stage where configurations can be visually managed and configured, along with an execution history of log data and processing of business-related feedback by which other components or stages can use for generating an implementation output and a further comparison of any differences in the configurations of the HAW or visual structure 210.

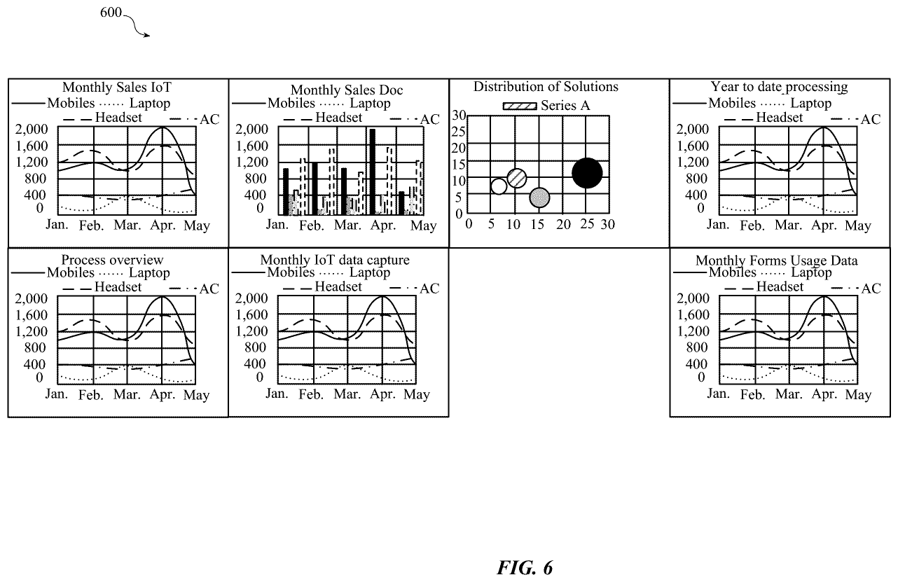

In another example, in response to receiving a central log-in access, an analytics component 510 can generate real time analytics of the wheel structure or visual sequence structure 210 and associated processes based on logs of the wheel structure. Analytics and reports can be provided by the analytics component 510 such as illustrated with respect to FIG. 6 such as with analytics as monthly sales IoT, monthly sales documents, distribution of solutions, year to date processing, from top-left to right; as well as process overview, monthly IoT data capture, or monthly forms usage data, from bottom-left to right. Each curve of the graphs can represent mobile, laptop, autonomic computing, headset devices, for example, or others, across the horizontal axis as time, and the vertical axis as an amount or quantity, for example. A distribution of solutions can represent an amount across various systems or products, or other distribution, for example. Real time analytics can be configured from hyperautomation logs based on fundamental reports by interrogating the hyperautomation logs of various process of stages with their status and activity across disparate systems, third-party or not.

In another example, in response to receiving a central log-in access, the solution process component 512 can monitor individual transactions within one or more of disparate systems associated with the visually structured sequence 210 or HAW. Each transaction can be a process or application function of a stage with its outputs or the HAW visualization of an end process solution with its outputs. This enables an observation or monitoring of the constructed process (the end process solution) via the HAW or visual structure 210 based on the log information of each stage as a behind the scene view in real time across the disparate systems in the enterprise.

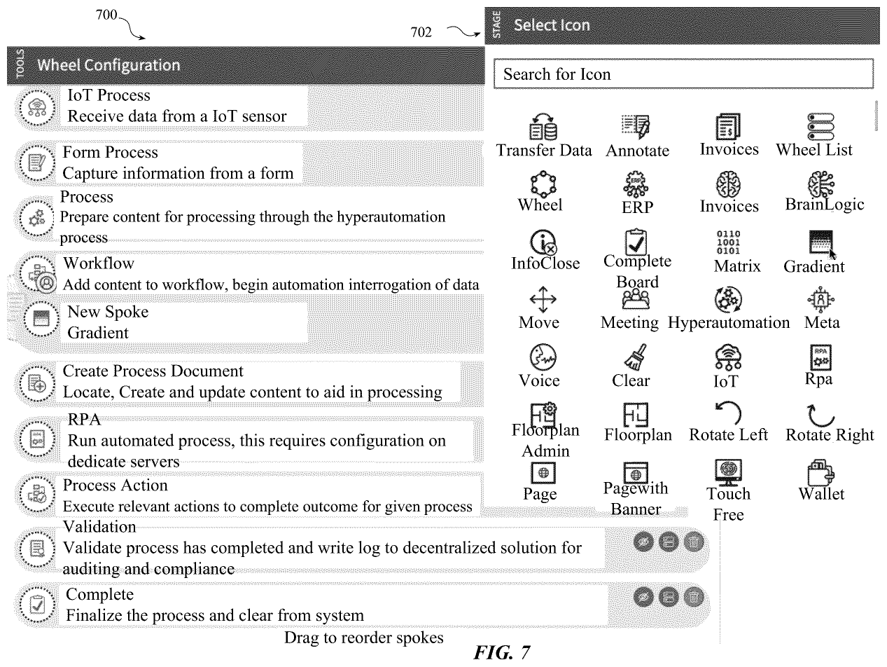

Referring to FIG. 7, illustrated is an example of administrative options 700 and 702 that can be configured via the automation administration component 508 to execute various wheel structures, HAWs, or visually sequenced structures 210 for automation across the disparate systems of one or more products based on the visual configuration of each structure. Here, an administrative section or view can enable evaluation of each HAW configuration for each end process solution, including a wheel or visual structure overview, an administration option, analytics option, hyperautomation client, case management or viewing logs, for example. Upon receiving a selection of the process content stage 308 a wheel configuration can be configured, for example, by selecting a source system or associated disparate system, as well as potentially add an additional disparate system. Adding a new source system can include discovering different configuration items or associated (sub)-processes, features, forms, or content, for example. At 700, different processes can be edited, or moved around the visual structure to come before or after other stages, which flow together and are joined via spokes by the connection manager component 506, for example.

Various icons 702 representing different application functions can be selected and added or removed, depending on the disparate system being added or edited in the HAW component 300. Each icon can represent application functions as a template or transaction among the wheel configuration or visually structured sequence 210, which can then be moved around or removed once added as a part of the end process solution being functionally visualized thereby.

Multiple HAWs can be configured by the HAW component 300. As such, an enterprise or organization can model each and every solution based on metadata within a single HAW or HAWs. Every different process can likewise be modeled in one system for disparate systems, in which analytics can further be generated or monitored via the analytics component 510.

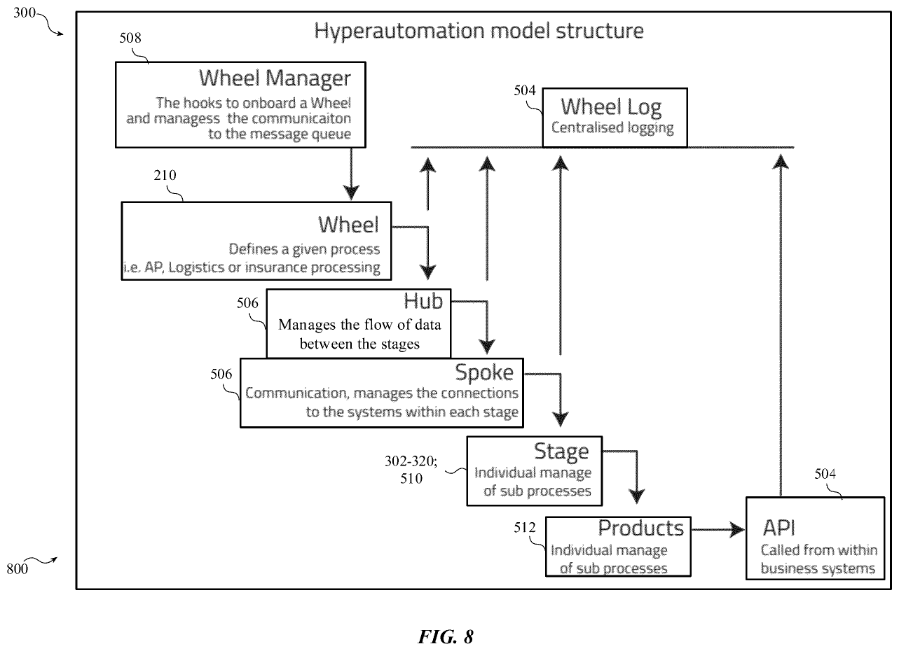

Referring to FIG. 8, illustrated is an example model structure 800 of the HAW system or component 300 and associated processes in accord with various aspects. The model 800 comprises various processes as a part of components coupled to demonstrate the association of application functions. The model 800 comprises a wheel manager that can function as the processes of the automation administration component 508. The wheel manager processes via the automation administration component 508 on-board information for configuring and modifying a visual structure by managing communications to a message queue for the wheel structure. The wheel structure or visual structure 210 receives data input from the wheel manager processes to define a given process or end process solution (e.g., accounts payable, logistics or insurance processing, or the like). A hub and the spoke(s) can operate as processes of the connection manager component 506. As a hub, the connection manager component 506 manages the flow of data between the different stages of the visual structure 210. Each spoke or connection between the stages (e.g., 302-320) individually manage process or sub-processes there-between as a part of the end process solution. The outputs of one stage can be the inputs of another until completion. The stage(s) 302-320 are configured at least in part by the analytics component 510 to monitor and report real time feedback to the whole systems as logs, for example, which the wheel and hub also provide data for report to the wheel log. Each of the sets of processes hold a reference to the parent processes with a one to many relationship to the other. At the final function(s), the products or end process solutions are managed by the solution process manage component 512.

The data from each of the sets of functions at the wheel 210, the hub and spoke(s) 506, and the API of a disparate system 504 communicate and are configured by the log on component 504. The wheel log configured by or as the log on component 504 provides the centralized logging. As such, metadata can be extracted from disparate systems to be monitored or modified for testing within the enterprise without interfering with or replacing processes managed at each of the disparate systems. The logging component 504 and associated processes can in one aspect utilize a NoSQL database as a mechanism for storage and retrieval of data being modeled. In this manner data changes can be propagated to all nodes (e.g., sets of processes and associated components) within the HAW component or system 300, for example. This could be an optional aspect as configured by an end user via the automation administration component 508, for example.

Automation processing of the HAW can be configured to utilize API(s), messaging queue(s), and multiple logging options, including NoSQL, Workview and Json files stored in a document repository. These tools with the aspects herein can be implement via the HAW to establish automation of the end process solution across disparate systems without re-establishing or managing the disparate system or associated settings directly or by independently logging into the disparate system to configure items or content. Case management options can also be configured in which cases or project cases are opened for each HAW or visually structured sequence 210 in order to help manage some of the features or aspects while extending the solution without any code or system updates.

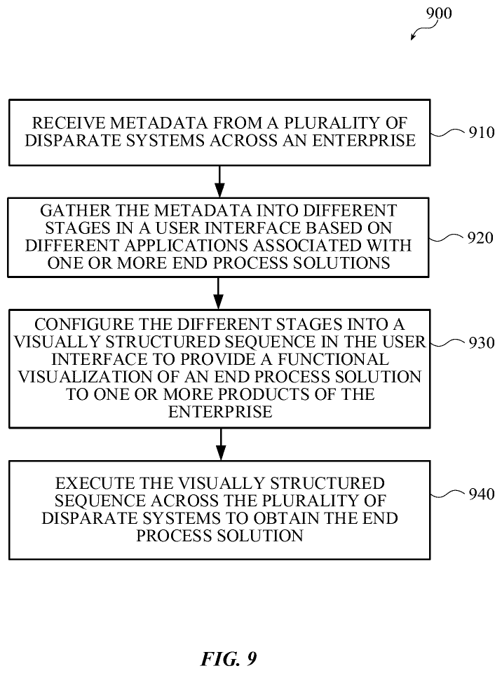

FIG. 9 illustrates an example process flow 900 for a cloud-based system that visually generates end process solutions or products across disparate systems of an enterprise with a hyperautomation wheel. The method, performed by a cloud-based system, initiates at 910 with receiving, by one or more processors, metadata from a plurality of disparate systems across an enterprise.

At 920, the process flow 900 further comprises gathering the metadata into different stages in a user interface based on different applications associated with one or more end process solutions.

At 930, the process flow 900 further comprises configuring one or more of the different stages into a visually structured sequence in the user interface that provide a functional visualization of an end process solution to one or more products of the enterprise.

At 940, the process flow 900 further comprises executing the visually structured sequence across the plurality of disparate systems to obtain the end process solution.

In an aspect, process flow 900 can further include receiving feedback of individual transactions associated with the end process solution based on the visually structured sequence. Analytics can be based on the feedback, wherein the visually structured sequence comprises a wheel structure of different stages associated with different processes that provide the feedback. The visual structure or visually structured sequence can be modified so that the process flow 900 can include modifying the visually structured sequence to have a fewer or a greater amount of stages based on feedback of individual transactions (or results of various processes).

In response to receiving a central log-in access across the plurality of disparate systems: the process flow 900 can include providing access to the metadata of the plurality of disparate systems, wherein the metadata is associated with different automation processes of one or more different products; managing connections to the plurality of disparate systems based on a security token exchange; generating real time analytics of associated processes of the visually structured sequence based on logs of the associated processes; and re-configuring the visually structured sequence based on changes in a process of the different automation processes by adding a new source system with the plurality of disparate systems, adding or removing a stage of the visually structured sequence, or modifying a process from among a stage of the visually structured sequence.

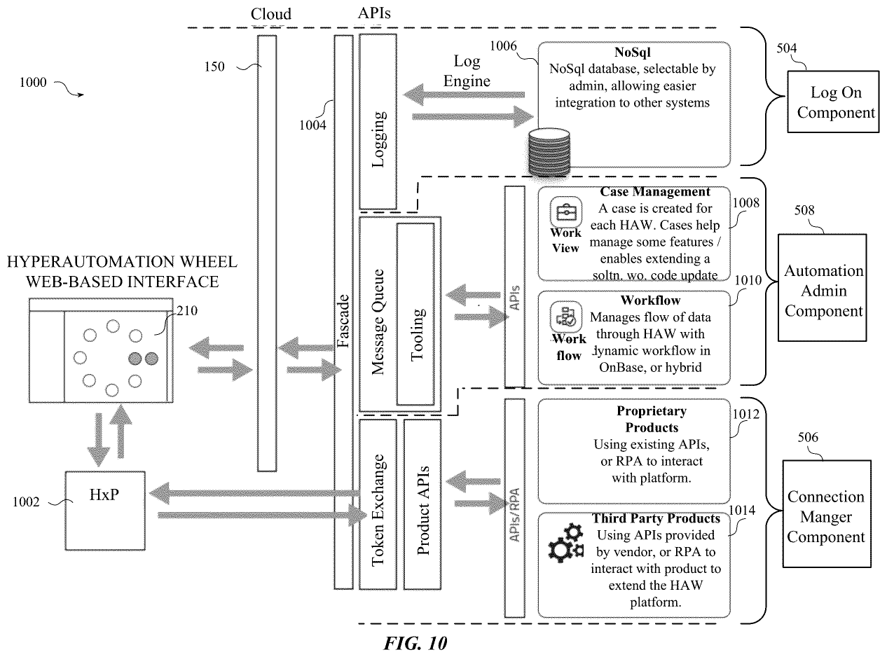

Referring to FIG. 10, illustrated is a diagram of an example hyperautomation wheel system 1000 in accord with various aspects. The visual structure 210 is configured as a HAW in a web-based interface to define an end process solution across disparate systems 520 via a cloud network 150, for example. As discussed with reference to FIG. 5, the HAW system 1000 can include a log on component 504, a connection manager component 506, and an automation administration component 508, among other components configured to capture, configure, test, monitor and implement end process solutions defined by the HAW or visual structure 210 across disparate systems without having to independently configure, interfere with processes that are managed at each of the disparate systems. The HAW or visual structure 210 can represent one or more HAWs or visual structures 210 defining an end process solution or product, respectively, within an enterprise or business.

The system 1000 illustrates the various interfaces among the functions of the components 504 thru 508 as an example interface configuration between different processes or sub-processes for configuring and implementing the visual structure 210 as end process solution. As discussed with respect to FIG. 5, the log on component 504 is configured as a log on engine that interfaces with the disparate systems via a series of APIs, for example, through a facade 1004 with a uniform view of to the cloud and user interface with the wheel structure or visually structured sequence 210 of an end process solution. The log on component 504 operates as centralized and unified logging engine that provides access to the metadata from a cloud based network 150 through logging APIs of the disparate systems without having to independently access each disparate system or without requiring individual user access associated with each of the disparate systems, based on the APIs created from the metadata. In an aspect, a NoSql database 1006 can be utilized or selected by an end user or administrator to allow easier integration to other systems, for example, and into a HAW format. The component 504 can extract and transform logs of the different sources systems (disparate systems) via a logging function (“logging”) via the APIs. Additionally data can be applied to aid for analytical use and enable the disparate systems to be centrally managed via the HAW component or device 300 with the metadata. The Log ON component 504 can interface between the NoSql database and Logging at APIs with facade 1004.

The automation administration component 508 includes APIs associated with different stages such as a workview stage, a workflow stage (e.g., 310), or other stage to manage the HAW system. Relevant or associated information can get pushed to each stage via the automation administration component 508 from the metadata of the disparate systems as source systems, thereby enabling one or more application function(s) associated with a particular stage (e.g., 302 thru 320) to operate accordingly as part of an end process solution defined by the HAW. For example, a workview stage 1008 can operate to create a case for each HAW being configured. These cases can facilitate managing various features and extending an end process solution without necessarily a code update to the disparate systems. Another stage can be a workflow stage 1010 that is similar to the workflow stage 310 of FIG. 3 to assist the flow of data via the HAW from one or more disparate systems or a hybrid of process from various systems, as with any other stage discussed herein. Other stages can also be configured as discussed via the automation administration component 508 for automation processes to be implemented, monitored and configured across disparate systems of the enterprise. The automation administration component 508, for example, can thus enable the flow of information between each stage (e.g., 302 thru 320, 1008, 1010 or other stage) via message queue and an associated tooling component with the relevant tooling data for each function of the stage via the facade to the cloud and the HAW 170 or 300.

The connection manager component 506 also operates to connect and communicate between the disparate systems including proprietary systems 1012 or third party products or systems 1014. The connection manager component 506 can use existing APIs or create APIs with the metadata or utilize the RPA to interact with the HAW system platform. As previously discussed, the product APIs can enable communication via a security exchange or token exchange with an HxP 1002, for example. This can enable connections to various disparate systems based on a session or according to session based connections.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

A first example is an apparatus to be employed in a network device, comprising: a memory; and one or more processors configured, when executing instructions stored in the memory, to: receive metadata from a plurality of disparate systems across an enterprise; gather the metadata into different stages of different applications involved with an end process solution; and configure one or more of the different stages into a wheel structure that provides a functional visualization to the end process solution according to one or more different products.

A second example can include the first example, wherein the plurality of disparate systems comprise at least one of a sensor system, a process automation system, or an enterprise retail management (ERM) system that operate on a platform of the enterprise with or without a third-party system to the enterprise, wherein the plurality of disparate systems include one or more of: Hyland Software Product Suite, OnBase, Robotic Process Automation (RPA), Workday Financial Management, or Systems Applications and Products (SAP).

A third example can include the first or second example, wherein the enterprise comprises one or more businesses with business processes and automation process performed by the different applications.

A fourth example can include any one or more of the first through third examples, wherein the one or more processors are further configured to: provide a log-in interface that centralizes and unifies access to the metadata of the plurality of disparate systems, without requiring individual user access associated with each of the plurality of disparate systems, based on application programming interfaces (APIs) created from the metadata of the plurality of disparate systems.

A fifth example can include any one or more of the first through fourth examples, wherein the one or more processors are further configured to: reconfigure at least one sub-process or stage of the end process solution across the plurality of disparate systems within a platform of the enterprise based on a visual re-configuration of the wheel structure, wherein the end process solution is associated with one or more automation process, one or more products, or both.

A sixth example can include any one or more of the first through fifth examples, wherein the one or more processors are further configured to: in response to receiving a central log-in access for the wheel structure: provide access to the metadata of the plurality of disparate systems, wherein the metadata is associated with different automation processes of one or more different products; manage connections to the plurality of disparate systems based on a token exchange with a cloud-based platform; generate real time analytics of the wheel structure and associated processes of the wheel structure based on logs of the wheel structure; and enable re-configuring the wheel structure based on changes in a process of the different automation processes by adding a new source system with the plurality of disparate systems, adding or removing a stage of the wheel structure, or modifying a process flow sequence from among stages of the wheel structure.

A seventh example can include any one or more of the first through sixth examples, wherein the one or more processors are further configured to: monitor individual transactions within at least one of the plurality of disparate systems associated with the wheel structure based on an application function of each stage of the wheel structure, wherein stages of the wheel structure comprise visual spokes of the wheel structure that provide template or process models for the end process solution.

An eighth example can include any one or more of the first through seventh examples, wherein the one or more processors are further configured to: execute various wheel structures including the wheel structure for automation across the plurality of disparate systems for the one or more different products based on a visual configuration of each wheel structure.

A ninth example can be a system of a cloud based sever comprising: a memory; and one or more processors configured, when executing instructions stored in the memory, to: receive metadata from a plurality of disparate systems across an enterprise; gather the metadata into different stages in a user interface based on different applications associated with one or more end process solutions; and configure one or more of the different stages into a visually structured sequence in the user interface that provide a functional visualization of an end process solution to one or more products of the enterprise.

A tenth example can include the ninth example, wherein the plurality of disparate systems comprise different platforms across different segments of businesses associated with the enterprise, including one or more third-party systems, and wherein the plurality of disparate systems comprise different technologies including at least one of: sensor IoT based devices, systems applications and products (SAP) components, enterprise retail management (ERM) processes, automation system devices, or security services, wherein the plurality of disparate systems include one or more of: Hyland Software Product Suite, OnBase, Robotic Process Automation (RPA), Workday Financial Management, or Systems Applications and Products (SAP).

An eleventh example can include any one or more of the ninth through tenth examples, wherein the one or more processors are further configured to: extract the metadata from the plurality of disparate systems to monitor or modify the metadata for testing within the enterprise without interfering with or replacing processes managed at each of the plurality of disparate systems.

An twelfth example can include any one or more of the ninth through eleventh examples, wherein the one or more processors are further configured to: configure and re-configure, based on user input, multiple different visually structured sequences into wheel structures based on particular end-to-end solutions for the enterprise; monitor stages of each of the wheel structures with log information from one or more processes associated with the stages; and test configurations of the wheel structures by monitoring metrics across the one or more processes.

An thirteenth example can include any one or more of the eleventh through twelfth examples, wherein the one or more processors are further configured to: execute computer executable components, the computer executable components comprising: a log on component that provides a single log-in to the system by centralizing and unifying the metadata from among different platforms with the plurality of disparate systems, including segments of businesses associated with the enterprise and third-party systems based on application programming interfaces (APis) created among the plurality of disparate systems; and a connection manager component that manages connections to the plurality of disparate systems based on a security exchange to obtain the metadata and enable access with the single log-in.

A fourteenth example can include any one or more of the ninth through the thirteenth examples, wherein the computer executable components further comprise: an analytics component that generates real time analytics and reports of associated processes of stages of the visually structured sequence; and an automation administration component that enables re-configuring the visually structured sequence based on changes in an automation process by adding a new source system with the plurality of disparate systems, adding or removing a stage of the visual structured sequence, or modifying a process flow sequence from among stages of the visual structured sequence, wherein the visually structured sequence is a wheel structure comprising spokes of the wheel structure associated with the stages.

A fifteenth example can include any one or more of the ninth through the fourteenth examples, wherein the computer executable components further comprise: a solution process component that monitors individual transactions within at least one of the plurality of disparate systems associated with the visually structured sequence.

A sixteenth example can include any one or more of the ninth through the fifteenth examples, wherein the one or more processors are further configured to: modify the visually structured sequence to a different visually structured sequence by reconfiguring at least one sub-process or stage of the end process solution across the plurality of disparate systems, wherein the end process solution is associated with one or more automation process, one or more products, or both.

A seventeenth example can be an method, performed by a cloud-based system, comprising: receiving, by one or more processors, metadata from a plurality of disparate systems across an enterprise; gathering the metadata into different stages in a user interface based on different applications associated with one or more end process solutions; configuring one or more of the different stages into a visually structured sequence in the user interface to provide a functional visualization of an end process solution to one or more products of the enterprise; and executing the visually structured sequence across the plurality of disparate systems to obtain the end process solution.

An eighteenth example can include the seventeenth example, further comprising: receiving feedback of individual transactions associated with the end process solution based on the visually structured sequence; and generating analytics based on the feedback, wherein the visually structured sequence comprises a wheel structure of different stages associated with different processes.

A nineteenth example can include any one or more of the seventeenth through eighteenth examples, further comprising: modifying the visually structured sequence to have a fewer or a greater amount of stages based on feedback of individual transactions.

A twentieth example can include any one or more of the seventeenth through nineteenth examples, further comprising: in response to receiving a central log-in access across the plurality of disparate systems: providing access to the metadata of the plurality of disparate systems, wherein the metadata is associated with different automation processes of one or more different products; managing connections to the plurality of disparate systems based on a security token exchange; generating real time analytics of associated processes of the visually structured sequence based on logs of the associated processes; and re-configuring the visually structured sequence based on changes in a process of the different automation processes by adding a new source system with the plurality of disparate systems, adding or removing a stage of the visually structured sequence, or modifying a process from among a stage of the visually structured sequence.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. An apparatus to be employed in a network device, comprising:
a memory; and
one or more processors configured, when executing instructions stored in the memory, to:
receive metadata from a plurality of disparate systems across an enterprise;
gather the metadata into different stages of different applications involved with an end process solution; and
configure one or more of the different stages into a wheel structure that provides a functional visualization to the end process solution according to one or more different products.

2. The apparatus of claim 1, wherein the plurality of disparate systems comprise at least one of a sensor system, a process automation system, or an enterprise retail management (ERM) system that operate on a platform of the enterprise with or without a third-party system to the enterprise, wherein the plurality of disparate systems include one or more of: Hyland Software Product Suite, OnBase, Robotic Process Automation (RPA), Workday Financial Management, or Systems Applications and Products (SAP).

3. The apparatus of claim 1, wherein the enterprise comprises one or more businesses with business processes and automation process performed by the different applications.

4. The apparatus of claim 1, wherein the one or more processors are further configured to:
provide a log-in interface that centralizes and unifies access to the metadata of the plurality of disparate systems, without requiring individual user access associated with each of the plurality of disparate systems, based on application programming interfaces (APIs) created from the metadata of the plurality of disparate systems.

5. The apparatus of claim 4, wherein the one or more processors are further configured to:
reconfigure at least one sub-process or stage of the end process solution across the plurality of disparate systems within a platform of the enterprise based on a visual re-configuration of the wheel structure, wherein the end process solution is associated with one or more automation process, one or more products, or both.

6. The apparatus of claim 1, wherein the one or more processors are further configured to:
in response to receiving a central log-in access for the wheel structure:
provide access to the metadata of the plurality of disparate systems, wherein the metadata is associated with different automation processes of one or more different products;
manage connections to the plurality of disparate systems based on a token exchange with a cloud-based platform;
generate real time analytics of the wheel structure and associated processes of the wheel structure based on logs of the wheel structure; and
enable re-configuring the wheel structure based on changes in a process of the different automation processes by adding a new source system with the plurality of disparate systems, adding or removing a stage of the wheel structure, or modifying a process flow sequence from among stages of the wheel structure.

7. The apparatus of claim 1, wherein the one or more processors are further configured to:
monitor individual transactions within at least one of the plurality of disparate systems associated with the wheel structure based on an application function of each stage of the wheel structure, wherein stages of the wheel structure comprise visual spokes of the wheel structure that provide template or process models for the end process solution.

8. The apparatus of claim 1, wherein the one or more processors are further configured to:
execute various wheel structures including the wheel structure for automation across the plurality of disparate systems for the one or more different products based on a visual configuration of each wheel structure.

9. A system of a cloud based sever comprising:
a memory; and
one or more processors configured, when executing instructions stored in the memory, to:
receive metadata from a plurality of disparate systems across an enterprise;
gather the metadata into different stages in a user interface based on different applications associated with one or more end process solutions; and
configure one or more of the different stages into a visually structured sequence in the user interface that provide a functional visualization of an end process solution to one or more products of the enterprise.

10. The system of claim 9, wherein the plurality of disparate systems comprise different platforms across different segments of businesses associated with the enterprise, including one or more third-party systems, and wherein the plurality of disparate systems comprise different technologies including at least one of: sensor IoT based devices, systems applications and products (SAP) components, enterprise retail management (ERM) processes, automation system devices, or security services, wherein the plurality of disparate systems include one or more of: Hyland Software Product Suite, OnBase, Robotic Process Automation (RPA), Workday Financial Management, or Systems Applications and Products (SAP).

11. The system of claim 9, wherein the one or more processors are further configured to:
extract the metadata from the plurality of disparate systems to monitor or modify the metadata for testing within the enterprise without interfering with or replacing processes managed at each of the plurality of disparate systems.

12. The system of claim 9, wherein the one or more processors are further configured to:
configure and re-configure, based on user input, multiple different visually structured sequences into wheel structures based on particular end-to-end solutions for the enterprise;
monitor stages of each of the wheel structures with log information from one or more processes associated with the stages; and
test configurations of the wheel structures by monitoring metrics across the one or more processes.

13. The system of claim 9, wherein the one or more processors are further configured to:
execute computer executable components, the computer executable components comprising:
a log on component that provides a single log-in to the system by centralizing and unifying the metadata from among different platforms with the plurality of disparate systems, including segments of businesses associated with the enterprise and third-party systems based on application programming interfaces (APis) created among the plurality of disparate systems; and
a connection manager component that manages connections to the plurality of disparate systems based on a security exchange to obtain the metadata and enable access with the single log-in.

14. The system of claim 13, wherein the computer executable components further comprise:
an analytics component that generates real time analytics and reports of associated processes of stages of the visually structured sequence; and
an automation administration component that enables re-configuring the visually structured sequence based on changes in an automation process by adding a new source system with the plurality of disparate systems, adding or removing a stage of the visual structured sequence, or modifying a process flow sequence from among stages of the visual structured sequence, wherein the visually structured sequence is a wheel structure comprising spokes of the wheel structure associated with the stages.

15. The system of claim 13, wherein the computer executable components further comprise:
a solution process component that monitors individual transactions within at least one of the plurality of disparate systems associated with the visually structured sequence.

16. The system of claim 13, wherein the one or more processors are further configured to:
modify the visually structured sequence to a different visually structured sequence by reconfiguring at least one sub-process or stage of the end process solution across the plurality of disparate systems, wherein the end process solution is associated with one or more automation process, one or more products, or both.

17. A method, performed by a cloud-based system, comprising:
receiving, by one or more processors, metadata from a plurality of disparate systems across an enterprise;
gathering the metadata into different stages in a user interface based on different applications associated with one or more end process solutions;
configuring one or more of the different stages into a visually structured sequence in the user interface to provide a functional visualization of an end process solution to one or more products of the enterprise; and
executing the visually structured sequence across the plurality of disparate systems to obtain the end process solution.

18. The method of claim 17, further comprising:
receiving feedback of individual transactions associated with the end process solution based on the visually structured sequence; and
generating analytics based on the feedback, wherein the visually structured sequence comprises a wheel structure of different stages associated with different processes.

19. The method of claim 18, further comprising:
modifying the visually structured sequence to have a fewer or a greater amount of stages based on feedback of individual transactions.

20. The method of claim 18, further comprising:
in response to receiving a central log-in access across the plurality of disparate systems:
providing access to the metadata of the plurality of disparate systems, wherein the metadata is associated with different automation processes of one or more different products;
managing connections to the plurality of disparate systems based on a security token exchange;
generating real time analytics of associated processes of the visually structured sequence based on logs of the associated processes; and
re-configuring the visually structured sequence based on changes in a process of the different automation processes by adding a new source system with the plurality of disparate systems, adding or removing a stage of the visually structured sequence, or modifying a process from among a stage of the visually structured sequence.
